(19) United States
(12) Patent Application Publication
(10) Pub. No.: US 2026/0211978 A1
(43) Pub. Date: Jul. 23, 2026

(54) SYSTEMS AND METHODS FOR CONTROL AUDITS USING CONTROL CLUSTERING

(71) Applicant: The PNC Financial Services Group, Inc., Pittsburgh, PA (US)

(72) Inventors: Joanna CERESERO, Arlington Heights, IL (US); Joseph JANICKI, McKees Rocks, PA (US); Louis CASTAGLIOLA, Staten Island, NY (US); Jim TARANTINO, Pittsburgh, PA (US)

(73) Assignee: The PNC Financial Services Group, Inc., Pittsburgh, PA (US)

(21) Appl. No.: 19/393,116

(22) Filed: Nov. 18, 2025

Related U.S. Application Data
(60) Provisional application No. 63/746,520, filed on Jan. 17, 2025.

(51) Int. Cl. G06F 18/232; G06Q 40/12

(52) U.S. Cl. CPC G06F 18/232; G06Q 40/124

(57) ABSTRACT

The present disclosure relates to a control auditing system that filters and groups controls and produces control clusters. In some embodiments, the system includes at least one processor. The processor is configured to receive input controls, assess their features to determine input control similarities, create feature datasets based on this similarity, generate a control clustering model that creates optimized control clusters, transform the control clusters to a readable file format, and prompt the control clustering model to produce control cluster labels in the readable format. In some embodiments, a method of input control management involves receiving input controls, assessing their features to determine similarities of the input controls, creating a feature dataset based on this similarity, generating a control clustering model that creates optimized control clusters, transforming the control clusters to a readable file format, and prompting the control clustering model to produce control cluster labels in a readable format.

### CROSS REFERENCE TO RELATED APPLICATIONS

This application claims the benefit of priority of U.S. Provisional Patent Application No. 63/746520, filed on Jan. 17, 2025, which is incorporated herein by reference in its entirety.

### TECHNICAL FIELD

The present disclosure generally relates to the fields of audit control management. More specifically, the present disclosure relates to systems and methods for conducting control audits using control clustering systems.

### BACKGROUND

For internal audit team-associated organizations or entities, there are always critical issues that must be addressed, while the internal audit team incorporates a data-driven solution to assist its auditing procedure. Exemplary issues may include how to ensure that an internal audit team focuses on critical material coverage areas, how an internal audit team can detect unknown risks in auditing, and how an internal audit team can address blind spots within the auditing process.

In dealing with these exemplary issues for performing data-driven solutions, internal audit teams may encounter a few difficulties. For example, internal audit teams may face issues with receiving data from a multitude of data sources that are not consolidated. Working through such data can present a time-intensive audit planning process. The internal audit team may also need to determine in-scope and out-of-scope controls. Making determinations about controls may be highly subjective, such that rationales for making such determinations may be significantly inconsistent between audits. During the audit planning process, internal audit teams may not perceive unknown, undiscovered, or unaccounted-for risks for making an operable audit plan. Finally, the audit planning procedure may require integral involvement of the internal audit team and other various departments and directing dialogs between these groups may be complicated.

In summary, for an ordinary internal auditing procedure that requires a data-driven solution, there are many issues with respect to handling unknowns, focusing on critical issues, and making decisions based on the most up-to-date data. However, in dealing with these issues, scattered information, subjective judgements, unknown risks, and intertwined communications may form obstacles to generating the required data-driven solution, i.e., an operatable auditing plan. Therefore, a solution is needed to streamline and simplify the auditing process and allow for a more informed engagement planning process with data driven decision making.

The disclosed systems and methods provide a solution for auditing inefficiencies. The disclosed embodiments provide a solution that allows a user to conduct audit engagements using pre-determined groups of related controls. Through machine learning models, the user can easily access all related controls relevant to an auditing engagement. By streamlining the audit control identification and gathering process, the disclosed systems and methods for automating control clustering reduce the time required to find related controls and the chance of unknown risks causing compliance concerns due to unaudited controls.

### SUMMARY

For overcoming the above-mentioned issues, the present disclosure relates to an automated control auditing system able to filter and group audit controls and produce control clusters based on input datasets using control clustering models generated within the control auditing system.

In some embodiments, the system may include at least one processor. In some embodiments, the processor may be configured to receive input controls, assess their features to determine similarities of the input controls, create feature datasets based on the determined similarities, generate a control clustering model that creates optimized control clusters based on optimization of at least one of a feature weight, a feature dataset, or the input controls, transform the control clusters to a readable file format based on the optimized control clusters, and prompt the control clustering model to produce output labels in the readable format.

According to some embodiments, the processor may be further configured to determine feature weights and descriptions.

According to some embodiments, feature optimization may be stochastic.

According to some embodiments, the feature optimization may include minimizing the feature weight of the input controls to an optimal size.

According to some embodiments, minimizing the feature weight of the input controls of a control cluster may be completed to maximize at least one metric of a control clustering model.

According to some embodiments, the control clustering model may perform a stochastic feature weight optimization process for features of the control clustering model to produce optimized maximal metrics of the control clustering model.

According to some embodiments, performing the feature optimization process may further include using one or more combinations of objective model metrics and subjective model metrics to produce the optimized maximal metrics.

According to some embodiments, the control clustering model may use silhouette scores as an objective metric and user feedback as a subjective metric to produce optimized maximal metrics.

According to some embodiments, the feature weight of the input controls may be minimized using a maximum silhouette score.

According to some embodiments, the maximum silhouettes score may be an objective value indicator of a heightened similarity between a set of input controls.

According to some embodiments, the processor may be configured to use a minimization algorithm, wherein the minimization algorithm modulates the feature weight.

According to some embodiments, the system may further include an unsupervised control clustering model that optimizes maximal metrics of the control clusters produced, wherein the number of control clusters produced may be determined by balancing the objective model metrics and the subjective model metrics.

According to some embodiments, the number of control clusters created by the control clustering model may be a predetermined number of control clusters.

According to some embodiments, the control clustering model may use a ratio comparing a sum of dispersion between clusters generated by the control clustering model to a sum of dispersion within a given control cluster as an objective metric and user feedback as a subjective metric to produce optimized maximal metrics.

According to some embodiments, a control clustering model fit of the input controls may be compared to a control clustering model complexity as an objective metric and user feedback as a subjective metric to produce optimized maximal metrics.

According to some embodiments, a feature weight optimization process may include using one or more objective model metrics to produce optimized maximal metrics.

According to some embodiments, the control clusters may be further optimized by comparing the control clusters generated from at least two runs of a control clustering model using one or more subjective model metrics and one or more objective model metrics.

According to some embodiments, the control clustering model may be an unsupervised classification model.

According to some embodiments, the processor may be further configured to make at least one recommendation based on prior control clustering model outputs.

In some embodiments, the method of input control management may include receiving input controls, assessing their features to determine similarities of the input controls, creating feature datasets based on the determined similarities, generating a control clustering model that creates optimized control clusters based on optimization of at least one of a feature weight, a feature dataset, or the input controls, transforming the control clusters to a readable file format based on the optimized control clusters, and prompting the control clustering model to produce output labels in the readable format.

According to some embodiments, the readable file format may be a spreadsheet.

According to some embodiments, the output labels may be created using a processor and stored in a database.

According to some embodiments, the control clustering model may track and implement control cluster optimization.

It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 illustrates auditors desiring a system able to find and group relevant audit controls, consistent with disclosed embodiments.

FIG. 2 illustrates an exemplary solution for simplifying control auditing, consistent with disclosed embodiments.

FIG. 3 illustrates an embodiment of an exemplary system for performing the disclosed control auditing system, consistent with disclosed embodiments.

FIG. 4 is a block diagram showing an exemplary server, consistent with disclosed embodiments.

FIG. 5 illustrates an embodiment of an exemplary flowchart diagram for performing the disclosed control auditing system, consistent with disclosed embodiments.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed, without departing from the envisioned embodiments. Thus, the materials, methods, and examples are illustrative only and are not intended to be necessarily limited.

The foregoing description is presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

As discussed elsewhere herein, the comprehensiveness of control audits is often limited by in-process issues, such as receiving data from a multitude of data sources that are not consolidated, determination of in-scope and out-of-scope controls, subjective perception of unknown, undiscovered, or unaccounted for risks, and cross functional communication between teams. Working through data from multiple data sources can be difficult due to differences in data format and storage methods, increasing the time required for a given audit engagement. Additionally, making determinations about what controls are in-scope versus out-of-scope of an audit and what risks are associated with certain controls is highly subjective. Due to this, rationales for making such determinations may be significantly inconsistent between audits. Moreover, creating clear and effective communication channels between teams can be difficult and make the auditing process even more cumbersome and time intensive. The present disclosure discloses a control auditing system that gathers and assesses controls for a given auditing engagement based on their similarities, generates a control cluster model, which then creates control clusters with shared features. The control auditing system allows auditors to more efficiently conduct audits on all relevant and related controls within an audit engagement.

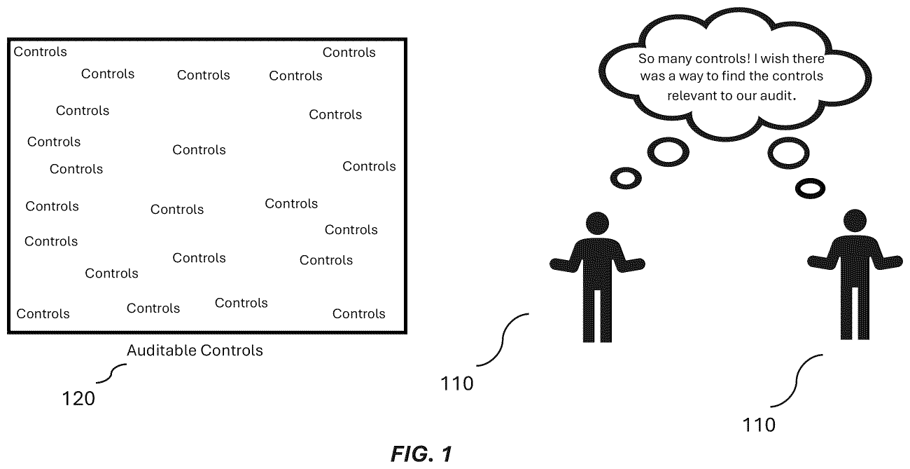

FIG. 1 illustrates auditors 110 desiring a system able to find and group related and relevant audit controls from available auditable controls 120. Auditable controls may be any controls used within an organization that can be audited. It is at times difficult to find the relevant auditable controls. Auditors 110 wish there was a system to improve the audit control selection process.

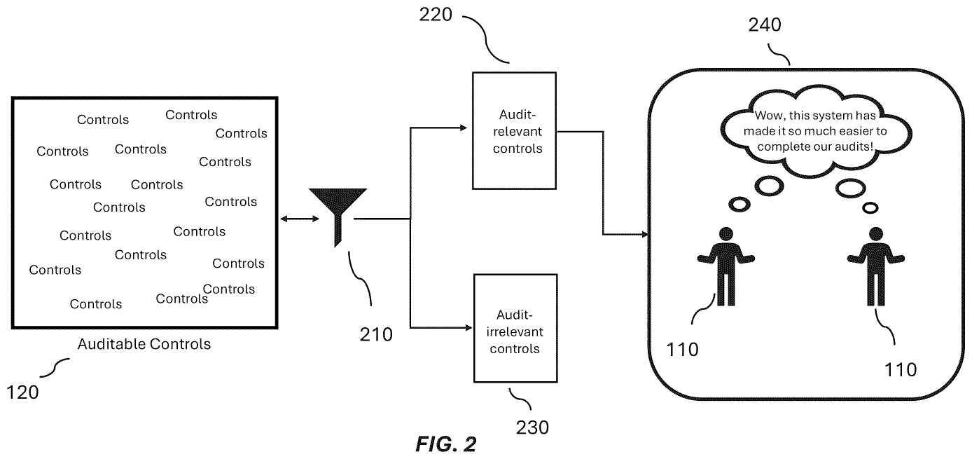

FIG. 2 illustrates an exemplary solution for simplifying control auditing, consistent with the disclosed embodiments. FIG. 2 illustrates auditable controls 120 and an exemplary solution 210 able to separate and group audit relevant controls 220 from audit irrelevant controls 230 and facilitating auditor's 110 access to audit relevant controls 220 during an audit engagement 240. Audit-relevant controls 220 may be controls related to a given audit that prevent or mitigate high risk issues for an organization. Audit-irrelevant controls 230 may be controls that are not related to a given audit that do not mitigate or prevent high risk issues for an organization.

An audit engagement may be an audit review of an organization's process and controls in a certain area of the organization. In a traditional audit engagement, auditors may review the auditable controls and data and determine which controls within the dataset are to be categorized as in-scope of the audit engagement and which controls within the dataset are to be categorized as out-of-scope of the audit engagement. In-scope controls may be specific processes or procedures included in an audit engagement. Out-of-scope controls may be specific processes and procedures that are not included in an audit engagement.

During an audit engagement, when an auditable control categorized as in-scope of the audit engagement is related to the subject of an audit engagement and justifiably included in the audit engagement, auditors may successfully conduct an efficient audit. However, when an auditable control categorized as in-scope of the audit engagement is minimally related or unrelated to the subject of an audit engagement, and thus out-of-scope of the audit engagement, auditors may have devoted time to reviewing said controls, taking time away from controls that are in-scope of the audit engagement.

Controls categorized as out-of-scope of the audit engagement may not be audited within a given audit engagement. When an auditable control categorized as out-of-scope of the audit engagement is minimally related to or unrelated to the subject of an audit engagement, auditors save time and avoid needless analysis of out-of-scope controls. However, when an auditable control categorized as out-of-scope of the audit engagement is related to the subject of an audit engagement, compliance issues may arise.

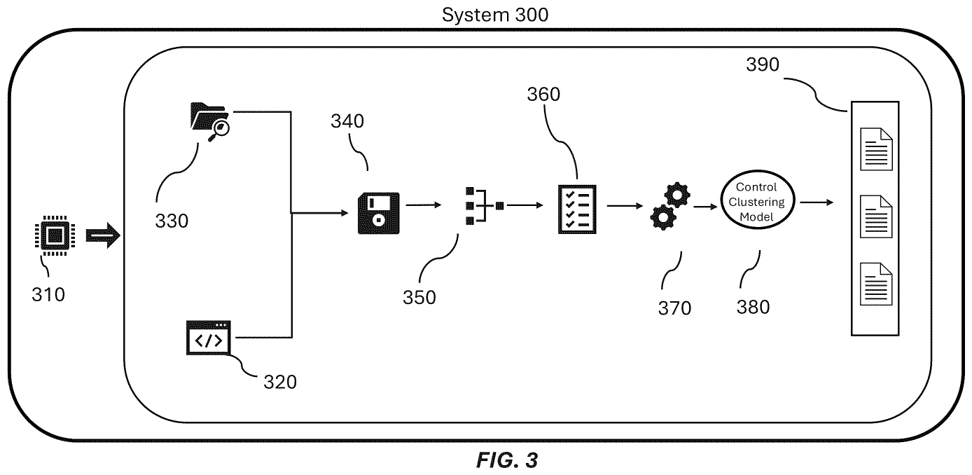

FIG. 3 is a schematic diagram illustrating one embodiment of system 300 for using the disclosed control auditing system according to some embodiments. In some embodiments, system 300 may include at least one processor 310, a configuration device 320, a library device 330, a data device 340, an aggregation device 350, a feature preparation device 360, a modeling device 370, a control clustering model 380, and an output device 390. While processor 310, configuration device 320, library device 330, data device 340, aggregation device 350, feature preparation device 360, modeling device 370, and output device 390 are shown within a single system 300, it is appreciated that any combination of these devices and components may exist outside of system.

The disclosed control auditing system may be designed to cover at least three types of risks. The first type of risk comes from auditors'subjective review of controls. Specifically, auditors'subjective decisions may be made based on auditors'experience and without objective explanations. The disclosed control auditing system may aid in effectuating objectivity required for decisions about controls and their clustering through use of objective model metrics. For example, an objective model metric may be silhouette scores, a score used to determine the similarity and correlation of features within a cluster. The second type of risk may be caused by controls in-scope of an audit engagement that may be overlooked by auditors in reviewing or testing. The disclosed control auditing system aids in ensuring a wholistic review and testing of controls by collecting contemporaneous and relevant controls and grouping them for audit review. The third type of risk lies in time spent on controls of lower risk that may otherwise squeeze the time spent on controls of higher risk. The control auditing system reduces or eliminates low risk control review by weighting and grouping controls based on their confirmed importance.

One or more processors 310 may be configured to execute commands of the other devices of system 300. A processor may be any type of computing device capable of executing instructions. A processor, such as processor 310 may include any physical device or group of devices having circuitry configured to perform one or more logic operations on an input or inputs. For example, processor 310 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. Processor 310 may take the form of, but is not limited to, a microprocessor, embedded processor, or the like, or may be integrated in a system on a chip (SoC). Furthermore, according to some embodiments, processor 310 may be from the family of processors manufactured by Intel®, AMD®, Qualcomm®, Apple®, NVIDIA®, or the like. The processor may also be based on the ARM architecture, a mobile processor, or a graphics processing unit, etc. The disclosed embodiments are not limited to any type of processor.

Configuration device 320 may be used for executing and improving control auditing system functions and for arranging files for initial feature weights and feature descriptions, consistent with disclosed embodiments. Control auditing system functions may be the tasks and actions performed by the control auditing system. For example, control auditing system functions may include control cluster optimization and data extraction. A feature may be a specific definable attribute or characteristic of a control. In some embodiments, feature weights may describe the prescribed importance of a feature within a given audit. In some embodiments, feature descriptions may be detailed explanations that highlight specific qualities or functionalities.

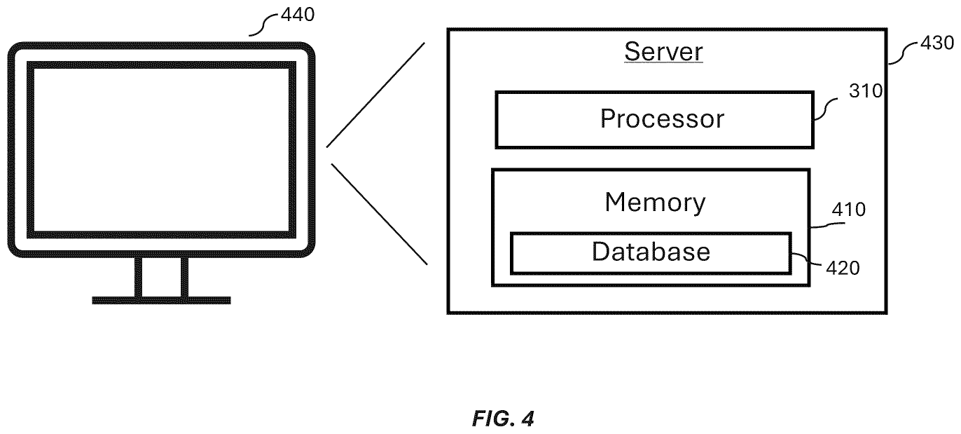

Configuration device 320 may be a means by which the control auditing system's improvements and layout are tracked for tool optimization. Specifically, configuration device 320 may store prior iterations of the control auditing system and its associated functions to capture changes such as the order of operation of the control auditing system or storage processing and access. In some embodiments, configuration device 320 may be one or more plain text files with a specific file extension. For example, configuration device 320 may take the form of, but is not limited to .cfg, .ini, .ir, or .json files. In some embodiments configuration device 320 may be found on or within a server as described with respect to FIG. 4.

Library device 330 may be configured to store functions for data processing and control clustering to prepare corresponding models, consistent with disclosed embodiments. Control clustering may be a method of grouping audit controls based on shared similarities. In some embodiments, the shared similarities may be determined by the control auditing system. In some embodiments, data processing may include extract, transform, load (ETL) processes, which may combine, clean, and organize data from multiple sources. Library device 330 may be a collection of code components used to perform specific tasks such as data collection and initial control grouping within the control auditing system. Code components may be self-contained, reusable pieces of software that may perform specific functions within the control auditing system such as control optimization. In some embodiments, library device 330 may contain pre-written functions that may be reused within the control auditing system. These prewritten functions may be used to reduce time required for execution of the control auditing system as they may provide foundational functions for the control auditing system to build upon. For example, the prewritten functions may include functions to receive input controls or preliminarily assess control features. In some embodiments, library device 330 may store connection codes on or within a database as described with respect to FIG. 4. Connection codes may be unique identifiers such as passwords that establish a connection between a device and a system. For example, connection codes may create the connection between a computing device as discussed with respect to FIG. 4 and the control auditing system.

Data device 340 may be configured to pull data used in executing the control auditing system and producing control cluster data from output device 390 as discussed below, consistent with disclosed embodiments. Data device 340 may be a module within the control auditing system able to hold and organize data from various sources to later use within a given control auditing system run. In some embodiments, data device 340 may organize data based on similarities found between controls. Data device 340 may pull data related to one of the following sources: Risk Control Self-Assessment (RCSA) information, RCSA control validation information, RCSA Risk Assessment Unit (RAU) information, issues information, Internal Audit (IA) application assessment information, and IA regulation assessment information. RCSA's may be an organization's self-assessment of control effectiveness. RCSA RAUs may be the area within an organization where audit risks associated with RCSA's are mapped. RCSA control validation information may be recordings of the accuracy and reliability of a given RCSA control. Issue information may be all information gathered related to potential problems or gaps within a business process. IA application assessment information may be data gathered from prior audit engagements related to applications used within a business. IA regulation assessment information may be regulation data gathered from prior audit engagements. In some embodiments, data device 340 may be found on or within a server as described with respect to FIG. 4.

Aggregation device 350 may be configured to cull and group all data relevant for use of the control auditing system, consistent with disclosed embodiments. Relevant data may be determined by completing a preliminary assessment of the data and control features and separating relevant data from data unrelated to a potential audit engagement. Aggregation device 350 may be a function within the control auditing system able to group controls based on shared features such as similar control focuses or importance of specific control features. In some embodiments, aggregation device 350 pulls and groups controls depending on their assessed importance or feature weight. Aggregation device 350 may group controls from different sources. These sources may include the RCSA data as discussed above. Preliminary grouping using aggregation device 350 further separates controls related to an audit engagement from those unrelated to an audit engagement, reducing the amount of downstream processing of the controls by the control auditing system. In some embodiments, aggregation device 350 may be stored on or within a server as described with respect to FIG. 4.

Feature preparation device 360 may be configured to prepare the features of the clusters produced by the control auditing system, consistent with disclosed embodiments. Feature preparation device 360 may be a function within the control auditing system used to prepare the control clusters for modeling by modeling device 370, based on feature weight. In some embodiments, feature preparation device 360 may rank and further group control clusters based on feature weights to create further separation between each control cluster. Increasing the separation between each control cluster may increase the interpretability of the clusters by making each cluster generated more distinct. The feature weights used by feature preparation device 360 may be prepared internally or externally to the control auditing system. In some embodiments, feature preparation device 360 is stored on or within a server as described with respect to FIG. 4.

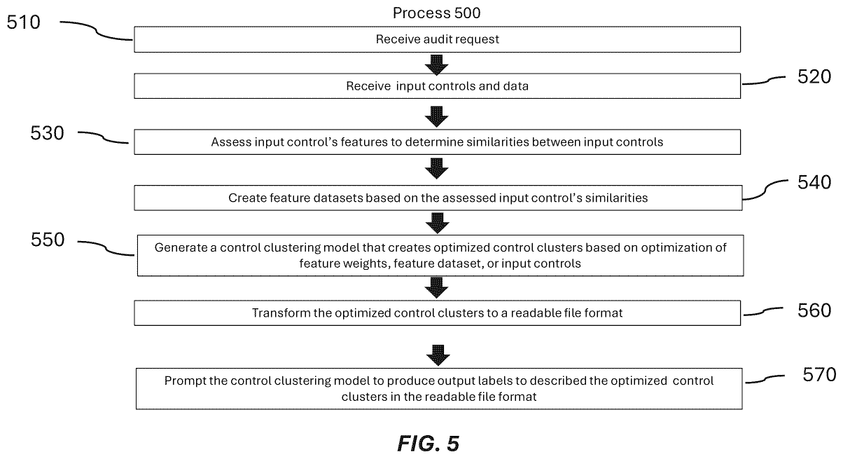

Modeling device 370 may be configured to generate control clustering model 380. Control clustering model 380 may be a machine learning model that creates the optimized control clusters as discussed with respect to FIG. 5, consistent with disclosed embodiments. It is to be appreciated that generating control clustering model 380 may include training or modifying an existing model. In some embodiments, training of control clustering model 380 may include teaching control clustering model 380 using data accessible to the control auditing system. The data used to train control cluster models may include previously generated control clusters and previously generated control clustering models.

Modeling device 370 may be one or more functions within the control auditing system that uses and optimizes the control feature weights from feature preparation device 360. Feature weight optimization may be a process performed by the control auditing system in which the weights of the controls used to generate control clusters may be adjusted to improve the performance, efficiency, and the accuracy of a control clustering model as discussed with respect to FIG. 5. In some embodiments, modeling device 370 may optimize feature weights during the creation of control clustering model 380 to improve model metrics. Model metrics may include the similarity of controls within a control cluster, the dissimilarity of controls within different control clusters, and feature weight minimization within the control auditing system. In some embodiments, modeling device 370 is stored on or within a server as described with respect to FIG. 4.

Machine learning models may be trained using at least one machine learning algorithm. Machine learning algorithms may be a form of artificial intelligence algorithm used to enable a computer to learn from, identify patterns of, and make predictions of data without explicit programming.

In some embodiments, machine learning algorithms may identify patterns, trends, and relationships within a dataset and use that information to create feature datasets to improve the performance of the control auditing system over time. A feature dataset may be a collection of related input controls that share at least one characteristic, these characteristics may be determined by machine learning algorithms. It is to be appreciated that machine learning algorithms may be one or more machine learning algorithms. The one or more machine learning algorithms may perform tasks simultaneously or sequentially from one another.

In some embodiments, machine learning algorithms may include supervised learning algorithms, unsupervised learning algorithms, reinforcement learning algorithms, semi supervised learning algorithms, and deep learning algorithms. Further, machine learning algorithms may include linear regression algorithms, logistic regression algorithms, decision trees, random forest algorithms, or neural networks.

Supervised learning algorithms may be a form of machine learning algorithm that learns from labeled data and may accurately predict outputs for new, unseen, or unknown data. Labeled data may be data with data tags that indicate what the specific data is. For example, a control for reduced manufacturing downtime may be labeled “manufacturing downtime control.” In some embodiments, control clustering model 380 may be trained using a supervised learning algorithm. Examples of supervised learning algorithms include regression algorithms and classification algorithms. The use of a specific algorithm may depend on the type of data assessed. For example, if the system is predicting feature weight, it may use a regression model, while it may use a classification algorithm when determining cluster labels as discussed with respect to FIG. 5.

Unsupervised learning algorithms may be a form of machine learning algorithm in which the data processed within the unsupervised learning algorithm does not contain labels or categories with the goal of finding patterns and relationships within the data without user or label guidance. In some embodiments, control clustering model 380 may be trained using an unsupervised learning algorithm.

Reinforcement learning algorithms may be a form of machine learning algorithm in which a decision-making entity learns how to make decisions from the data provided through trial and error. The decision-making entity may base its decisions on a specific goal that may be programmed within a system. For example, the goal may be to produce a pre-determined number of control clusters or obtain a specific silhouette score as discussed with respect to FIG. 5. In some embodiments, control clustering model 380 may use a reinforcement learning algorithm.

Semi-supervised learning algorithms may be a form of machine learning algorithm that may use both labeled data (as may occur with supervised learning algorithms) and unlabeled data (as may occur with unsupervised learning algorithms) to train a machine learning model. The semi-unsupervised algorithm may use insights from labeled data to assess data from unlabeled data. By doing so, semi-supervised learning algorithms reduce the need for data labeling, allowing the learning algorithm to more accurately assess data unknowns, such as control features. In some embodiments, control clustering model 380 may be trained using a semi-supervised learning algorithm.

Deep learning algorithms may be a form of machine learning algorithm that simulates the decision making of humans through use of multilayered neural networks. Multilayered neural networks may be interconnected parts of the deep learning algorithm that may allow the algorithm to receive data, transform the data, and create an output of the data. This may allow the deep learning algorithm to learn complex patterns in data. In some embodiments, control clustering model 380 may be trained using a deep learning algorithm.

Linear regression algorithms may be a form of supervised machine learning algorithm used to predict a continuous target variable based on one or more independent variables, assuming a linear relationship. These variables may include quantitative values (e.g. the number of control clusters generated) or categorical variables (e.g. control cluster labels). In some embodiments, control clustering model 380 may be trained using a linear regression algorithm.

Logical regression algorithms may be a form of supervised learning algorithm used to predict binary classification problems and in doing so, may predict the probability of a specific event occurring. For example, a logical regression algorithm may be used to determine whether a control belongs to a specific control cluster. In some embodiments, control clustering model 380 may be trained using a logical regression algorithm.

Random forest algorithms may be a form of machine learning algorithm that uses decision trees to make predictions by increasing the number of splits within the decision tree. In some embodiments, control clustering model 380 may be trained using a random forest algorithm.

In some embodiments, machine learning algorithms are specialized based on tasks such as classification, regression, clustering, or rule learning. In some embodiments, machine learning algorithms involve natural language processing, speech recognition, image recognition, computer vision, reinforcement learning, or dimensionality reduction. In some embodiments, machine learning algorithms translate audio language data using natural language processing or other speech recognition techniques into a different language (e.g., translating audio in Spanish to English audio). In some embodiments, machine learning algorithms translate audio language data using natural language processing or other speech recognition techniques into written transcripts. It is to be appreciated that machine learning algorithms may also translate spoken or written words from video into different languages.

In some embodiments, the machine learning algorithms implement feature engineering techniques, to select or create relevant features that will be used by a machine learning model. A machine learning model may be a computer program or software able to predict and decide without explicit programing, using algorithms. In some embodiments, specialized hardware accelerators (e.g., graphics processing units (GPUs) and tensor processing units (TPUs)) may be used to enhance the machine learning algorithm's accuracy and performance by decreasing the time required to complete computationally intensive tasks such as matrix multiplication. Machine learning algorithms may or may not be physically integrated into hardware. Some disclosed embodiments may be software-based and may not require any specified hardware support. In some embodiments, machine learning algorithms are implemented in software and run on processor 310. For example, the machine learning algorithms may be implemented in software (e.g., using Python, R, Java).

In some embodiments, the machine learning algorithm involves training the algorithm on a dataset. Training machine learning algorithms may involve collecting a dataset (e.g., from data device 340) that includes input features and corresponding target values. The collected dataset may be split into two parts (i.e., a training set and a testing set). The training set may be used to train the machine learning algorithm, and the testing set may be used to evaluate the machine learning algorithm's performance. Machine learning algorithms may make predictions on the training data using the current model parameters, which may be the most contemporaneous configurations of a machine learning algorithm. The model parameters may determine how the model processes data and controls and makes predictions based on this data and the controls. Further, machine learning algorithms may calculate the loss or error between predicted values and actual target values, where the loss represents how far off the machine learning algorithm's predictions are from the true values. In some embodiments, back propagation may be used to update the machine learning algorithm's parameters in the direction that reduces loss.

Further, an optimization machine learning algorithm may minimize the loss by iteratively adjusting the model parameters. For example, during training, machine learning algorithms may adjust their internal parameters to learn the patterns and relationships between input features and output labels. In some embodiments, training the machine learning algorithms may involve iterative optimization and model evaluation.

In some embodiments, machine learning algorithms are configured to access data devices 340, databases (e.g. database 420 as discussed with respect to FIG. 4), or other sources of data (e.g., files, APis, web services). Processor 310 may use software applications or scripts to process and extract relevant information from raw data (e.g., gathered data). For example, processor 310 may use data extraction scripts, extract, transfer, load (ETL) processes, or customized programs to extract information from gathered data. In some embodiments, processor 310 applies machine learning algorithms (e.g., natural language processing, image processing, database queries, data filtering, data aggregation) to extract audit relevant information from gathered data. In some embodiments, an administrator may determine parameters that cause the machine learning algorithms to extract the data, override the extraction process, or override data that has been extracted. For example, an administrator may set parameters that train the machine learning algorithms. In some embodiments, processor 310 extracts audit control information with machine learning algorithms using feature engineering techniques. For example, feature engineering may be used to engineer relevant features that capture audit control information based on source data.

Feature engineering refers to devices, systems, and methods for selecting, creating, or transforming features (e.g., source data) to improve performance of machine learning algorithms. For example, feature engineering may involve analyzing source data (e.g., a dataset) and identifying relevant variables, understanding variable distributions, and recognizing patterns and relationships with data. In some embodiments, feature selection involves choosing the most relevant features from the source data based on domain knowledge, statistical techniques, or automated feature selection algorithms. In some embodiments, feature engineering involves feature creation where new features from existing variables or data sources are generated. In some embodiments, feature creation involves mathematical transformations, interaction terms, binning, discretization, or encoding categorical variables into numerical representations. Feature creation may be conducted using generative artificial intelligence algorithms. Generative artificial intelligence algorithms may be a form of artificial intelligence algorithm that may, using computer processes and systems, create novel outputs by learning from and mimicking data to generate novel content.

In some embodiments, feature engineering involves normalizing numerical and scaling features (e.g., zero mean, zero-unit variance, or scaling to a predefined range). Feature engineering may also be used for dimensionality reduction, to reduce the number of features while preserving important features. Preservation of important features may be conducted by assessing objective and subjective metrics as discussed with respect to FIG. 5 and removing features that do not produce optimal values of these metrics.

In some embodiments, the machine learning algorithms may assess keyword triggers within a control. Keyword triggers may refer to specific words or phrases, that, when detected within a context, initiate a predefined action or response. For example, the machine learning algorithms may detect specific words and patterns in the words that prompt specific categorization of input controls (e.g., type of control, type of audit conducted, and purpose of audit control). Input controls may be auditable controls accessible by a processor as discussed with respect to FIG. 4 for use within the control auditing system. In some embodiments, the machine learning algorithms may include clustering algorithms for custom segmentation, recommendation systems for suggesting products, and predictive models for forecasting demands. Clustering algorithms may be a machine learning technique that groups similar data points together. Recommendation systems may provide suggestions based on a user's prior engagements with a system. Predictive models may analyze historical data to forecast future events or outcomes.

In some embodiments, machine learning algorithms may label the gathered data. These labels may describe the gathered data. For example, machine learning algorithms may annotate the source data with labels that represent specific categories of control clusters the user wants the machine learning algorithms to predict. In some embodiments, machine learning algorithms are trained on the labeled dataset using supervised learning techniques. Non-limiting examples of machine learning algorithms involve regression, classification, and clustering tasks, as discussed herein. In some embodiments, machine learning algorithms may be evaluated based on performance metrics such as accuracy, precision, recall, cross-validation or mean squared error and used to improve the machine learning algorithms.

In some embodiments, machine learning algorithms may detect, flag, and correct any potential data inconsistencies detected within the input controls. Data inconsistencies may be variances in the input controls that impact the input control clustering. Potential sources of data inconsistency may include data duplication, incomplete data, data formatting issues, data inaccuracy, data conflicts, and data integration issues. In some embodiments, machine learning algorithms may compare the control clusters to each other to optimize control cluster generation. The data comparison process for a given control cluster may reference previously generated control clusters.

To conduct training of control clustering model 380, modeling device 370 may communicate with a processor. In some embodiments, training of control clustering model 380 may include prompting control clustering model 380 to make predictions or make decisions using new data and controls available to the control auditing system. In some embodiments, training of control clustering model 380 may refer to the use of a machine learning algorithm that has been trained to learn relationships between input data and input controls and other associated attributes. Training of the control clustering model may include use of one or more of the following: supervised learning algorithms, unsupervised learning algorithms, reinforcement learning algorithms, semi supervised learning algorithms, deep learning algorithms, linear regressions, logistic regression algorithms, decision trees, random forest algorithms, or neural networks. Modeling device 370 may not be physically integrated into hardware. In some embodiments, modeling device 370 may be software based and may not require specific software support. For example, modeling device 370 may be implemented on software and run on a processor such as processor 310.

In some embodiments, modeling device 370 may modify existing control clustering models to assess new, unassessed controls and data obtained. Modifying existing control clustering models generated by modeling device 370 may entail accessing previously generated control clustering models and adjusting the model based on the needs of a given audit engagement. In some embodiments, the control clustering model may be control clustering model 380. In some embodiments, a processor may be used to access previously generated control clustering models. This processor may be processor 310.

Output device 390 may be configured to relay information for additional use, for example, audit information and final control cluster groupings for auditors to review. Output device 390 may produce the final product of the control auditing system. In some embodiments, output device 390 may produce one or more user readable file formats, for downstream use. The user readable file format may be a form of data or information that is understandable by a human user. In some embodiments, the readable file format may be in the form of one or more excel files, text files, or a combination of text and other visual elements. Output device 390 and its associated output may be stored or saved on or within a server as described with respect to FIG. 4. In some embodiments, output device 390 may produce output labels that describe the optimized control clusters created by control clustering model 380.

Before using the disclosed control auditing system, audit data may be prepared for the given audit engagement, for example, with the aid of data device 340. Data preparation may include preprocessing of the data and preliminary separation of controls. Preliminary separation of features may be an initial segregation and grouping of controls prior to downstream processing. In some embodiments, the audit data may be a regular or periodic snapshot of RCSA data. For example, the audit data may be a monthly snapshot of the RCSA data. In some embodiments, sources of the audit data may include RCSA data, issue data, internal audit (IA) application assessment data, and internal audit (IA) regulation data. RCSA data may be the primary source of generating the audit data. The RCSA data may include features of the audit data as well as a corresponding control's identity (i.e., control ID).

Issue data may be data gathered related to issues in the organization, either self-identified by the line of business, identified by internal audit, by a regulator, or by another person within an organization. Auditors may use issue data to obtain information about how the control clusters are generated. IA application assessment data may be data gathered related to applications used within an organization, in addition to the IA application's latest audit year's organizational information and the level of audit risk associated with each control. Similarly, IA regulation data may include application information, which may be used to provide internal audit regulation organizational information for each IA regulation. The audit data from the abovementioned sources may be tied to RCSA controls, and the audit data used for features may be aggregated to the control level to assist with clustering the controls. The control level may refer to the order that controls are presented within the control auditing system.

FIG. 4 is a block diagram showing an exemplary server, consistent with disclosed embodiments. Server 430 may include one or more processors 310, one or more memories 410, and one or more databases 420. Server 430 may include any form of computing device configured to receive, store, and transmit data. For example, server 430 may be a server configured to store files accessible through a network (e.g., a web server, application server, virtualized server, etc). Server 430 may be implemented as a Software as a Service (SaaS) platform through which software for auditing recorded user activity may be provided to an organization as a web-based service.

In some embodiments, memory 410 may include one or more storage devices configured to store instructions used by processor 310 to perform functions related to server 430. The disclosed embodiments are not limited to particular software programs or devices configured to perform dedicated tasks. For example, memory 410 may store a single program, such as a user-level application, that performs the functions associated with the disclosed embodiments or may include multiple software programs. Additionally, processor 310 may, in some embodiments, execute one or more programs (or portions thereof) remotely located from server 430. Furthermore, memory 410 may include one or more storage devices configured to store data for use by the programs. Memory 410 may include, but is not limited to a Random Access Memory (RAM), a Read-Only Memory (ROM), a hard drive, a solid state drive, an optical disk, other permanent, fixed, or volatile memory, a CD-ROM drive, a peripheral storage device (e.g., an external hard drive, a USB drive, etc.), a network drive, a cloud storage device, or any other mechanism capable of storing instructions.

In some embodiments, processor 310 may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, or by any other way that permits them to interact with each other.

In some embodiments, database 420 may be coupled to a server, such as server 430. Database 420 may be included on a volatile or non-volatile, magnetic, semiconductor, tape, optical, removable, non-removable, or other type of storage device or tangible or non-transitory computer-readable medium. Database 420 may also be part of server 430 or separate from server 430. When database 420 is not part of server 430, server 430 may exchange data with database 420 via a communication link. Database 420 may include one or more memory devices that store data and instructions used to perform one or more functions of the disclosed embodiments. Database 420 may include any suitable databases, ranging from small databases hosted on a workstation to large databases distributed among data centers. Database 420 may also include any combination of one or more databases controlled by memory controller devices (e.g., server(s), etc.) or software. For example, database 420 may include document management systems, Microsoft SQLTM databases, SharePointTM databases, OracleTM databases, SybaseTM databases, other relational databases, or non-relational databases, such as Mongo and others. In some embodiments, server 430 may include one or more input/output devices, communications devices, displays, and/or other interfaces (e.g., server-to-server, database-to-database, or other network connections). In some embodiments, server 430 may include processor 310 as described above.

In some embodiments, server 430, processor 310, memory 410, and database 420 may be located internally or externally of computing device 440. Computing device 440 may be a machine capable of performing computations, processing information, and executing programs. Computing device 440 and its components may be programmed to perform operations and techniques or may include digital electronic devices such as one or more application-specific integrated circuits (ASICs) or field programmable gate arrays (FPGAs) that are programmed to perform operations and techniques. In some embodiments, the control auditing system may be executed using computing device 440. Computing device 440 may be one or more desktop computer systems, portable computer systems, handheld devices, networking devices, or any other device that can incorporate hard-wired and/or program logic.

In some embodiments, computing device 440 may be controlled using one or more operating systems. Non-limiting examples of operating systems may include iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, computing device 440 may be controlled by a proprietary operating system. Operating systems may be a software program that may control and schedule computer processes for execution, perform memory management, provide file system networking, and system execution, such as execution of the control auditing system.

FIG. 5 is a flowchart diagram illustrating one exemplary embodiment of process 500 for executing the disclosed control auditing system. The description of FIG. 5 discusses components with respect to FIG. 3, consistent with disclosed embodiments. In some embodiments, in step 510, an audit may be requested, and at least one processor may be used to launch the control auditing system. In some embodiments, a configuration device may be used to assist with initial launch and execution of the control auditing system.

In some embodiments, after step 510 is completed, process 500 may proceed to step 520. At step 520, the control auditing system may receive input controls and all other accessible data. In some embodiments, the input controls and data may be received to a centralized repository. In some embodiments, the control auditing system may receive the input controls and data using a data device. Helper functions within a library device may be used for additional control retrieval and processing. In some embodiments, a configuration device may be used to connect the control auditing system to a database to access the input controls.

After the control auditing system has received the input controls and data in step 520, process 500 may proceed to step 530. At step 530, the control auditing system may assess the input control's features to determine their respective similarities. These similarities may include the source of the control, the subject of the control, the frequency of use of the control, and the associated risks of the control. In some embodiments, a data device may be used to determine the features of the controls received in step 520 and determine potential similarities shared between the controls.

After the control auditing system has found similarities between controls in step 530, process 500 may proceed to step 540. At step 540, the control auditing system may create feature datasets based on the assessed input control's similarities. In some embodiments, the datasets may be hierarchically ranked based on their pre-established importance. In some embodiments, the hierarchy of importance may be established by a manual or automated ranking system completed externally of or internally of the control auditing system respectively. In some embodiments, a feature preparation device may use the grouped control datasets to prepare the features used by a control clustering model.

Once the features of the control clustering model are prepared at step 540, process 500 may proceed to step 550. At step 550, a modeling device may generate a control clustering model that creates optimized control clusters. The process of weighting control cluster features may increase the maximal metrics used for clustering by further separating data points based on their weight.

In some embodiments, to ensure the usefulness of the control clusters created by the control auditing system, there may be a weighting requirement for the auditable data. The initial weighting values of the auditable data may be set by the control auditing system using a machine learning algorithm as discussed with respect to FIG. 3 or externally by an auditor. In some embodiments, the control auditing system performs a weight optimization process for features of the control clusters, which assists in forming well-defined clusters. Weight optimization may be a process performed by the control auditing system in which the weights of the controls used to generate control clusters may be adjusted to improve the performance, efficiency, and the accuracy of the control clustering model. Weight optimization may be performed by weight minimization as discussed below. The weight optimization process may be based on the objective model metrics such as the silhouette score of control clusters created by the control clustering model. In some embodiments, weight optimization may be based on one or more combinations of objective model metrics, such as the silhouette score and subjective model metrics such as user feedback. User feedback may be the opinions and information provided by users of the control auditing system and their experience using the control auditing system. The user feedback may be to specific actions of the control auditing system, such as weight optimization. In some embodiments, user feedback may be implemented using the machine learning algorithms, to, for example, train the machine learning algorithms.

In some embodiments, control features may first be weighted by respective importance to the audit engagement. After-feature weighting and before creating and using the control clustering model, the control auditing system may scale the feature weight values to accentuate and distance unrelated controls. The scaling of feature weights may be a method of normalization in which feature weight values are transformed to a similar scale to prevent or reduce data bias during processing. Data bias may be errors or inaccuracies in reviewing data, or the data itself that leads to misleading results. For example, feature weights may be produced using differing scales. For example, weight for a given set of features may be on a scale from 1-5, while weights from a different set of features may be on a scale from 1-10. In this instance, a control auditing system may appraise a weight of 10 as higher than a weight of 5. However, both values are the highest value within their respective scales and thus reviewing the values as differing from each other may introduce bias into the data. To remove this bias, the control auditing system may scale the weights based on the same metric by, for example, updating the scale of 1-5 to align with the scale from 1-10.

In some embodiments, the feature weight optimization process may be stochastic, meaning the optimization process may be random. This may result in a random distribution that may be analyzed statistically but may not be predicted precisely. Thus, for example, under the condition that the same input data may be applied for multiple runs, different sets of optimal feature weights may still be found, creating variations in the control clustering model.

In some embodiments, at step 550, the control auditing system may utilize a feature preparation device. A feature preparation device may optimize features of the control clustering model. The feature preparation device may optimize features of the control clustering model based on each features respective importance in the audit engagement. The feature's respective importances may be pre-trained by auditors, for example with the aid of a configuration device or using machine learning algorithms.

In some embodiments, feature optimization of the control clustering model may be performed through feature weight minimization. Feature weight minimization may be a method in which the influence of certain features within a model, for example a control clustering model, is constrained to reduce the complexity of the model, discourage large feature weights, optimize feature size, and maximize model metrics. This may promote model simplification, enhance data interpretability, and improve control metric maximization by the control clustering model by reducing or removing extraneous features unnecessary for control cluster generation. Model simplification may be the process of reducing the complexity of a model while maintaining the model's essential characteristics. Data interpretability may be how well a clustering model can understand and distinguish data. In some embodiments, feature minimization enhances the distinction between controls, improving model metrics and increasing a model's ability to interpret data.

At step 550, control metric maximization may be optimizing a specific performance metric of the control clustering model. These metrics may include the accuracy and precision of the control clusters generated by a control clustering model. It is appreciated that to conduct feature optimization, a control clustering model may balance feature weight minimization with control metric maximization. The process of balancing feature weight minimization with control metric maximization may be stochastic.

Minimization algorithms may be used in the minimization process to modulate the feature's weights to produce a model with a maximal metric for evaluating the quality of control clustering results using unsupervised machine learning. Minimization algorithms may be a form of machine learning algorithm as discussed with respect to FIG. 3. However, initial feature weights of the control cluster may lead to low feature metrics. Therefore, in some embodiments, the weight optimization process may be performed on the feature weights to find the control clustering model that has a maximum objective metric, for example, a control clustering model with a maximum silhouette score.

A silhouette score may be an objective value indicator of a heightened similarity between a set of input controls. The silhouette score may reveal a cluster correlation quality metric that may range from −1 to 1. The silhouette score may be used to measure how similar each control is in its own control cluster compared to other control clusters. Specifically, a silhouette score close to 1 indicates a control matches its cluster. If a control cluster's silhouette score is close to 1, it indicates that the control cluster is appropriate based on the controls it contains. A maximum silhouette score may refer to the highest possible silhouette score for a given dataset. For example, the maximum silhouette score for a given control cluster may be 1. A silhouette score close to −1 may indicate that a control does not match well with its control cluster. If a control cluster's silhouette score is close to −1, it may indicate that the control cluster is not appropriate based on the controls it contains.

In some embodiments, a modeling device may use the silhouette score for each control clustering model produced by the control auditing system to recommend additional controls to assess using control clustering models produced using the control auditing system. To make these recommendations, a modeling device may access and review prior control models and based on currently available controls suggest updates to a control model.

In some embodiments, a control clustering model may be an unsupervised control clustering model. An unsupervised control clustering model may be a form of machine learning algorithm as discussed with respect to FIG. 3 that creates cluster controls without need for explicit guidance or data labels. The unsupervised control clustering model may independently perform this task by discovering patterns, trends, groupings, structures, and relationships within the accessible data. In some embodiments, the unsupervised control clustering model may apply its learning from prior runs of the control clustering model to optimize control clustering for subsequent runs.

In some embodiments, a control clustering model may be an unsupervised classification model. An unsupervised classification model may be a form of machine learning algorithm as discussed with respect to FIG. 3 that assigns labels to control clusters without the use of predetermined labels or training examples. The controls accessible to the control auditing system may not include labels that may describe the type of control or the subject of the control. To overcome this, the control clustering model may discover patterns, trends, and relationships between controls and generate labels of the control clusters based on these patterns.

At step 550, tests may be performed using different model types, different sets of features, different scalers, and different numbers of clusters to assess the functionality and optimization of the control clustering model. In some embodiments, for example, the control clustering model may be an agglomerative Ward clustering model. The agglomerative Ward clustering model may be a criterion applied in hierarchical cluster analysis to choose pairs of clusters to merge at each iteration of control clustering. Merging control clusters may be done to create new clusters based on a different feature criteria. These mergers may be based on the optimal value of an objective function, for example, to reach a local maximum of a cluster metric like a maximal silhouette score.

In some embodiments, the applied agglomerative Ward clustering model may apply a different number of control clusters (value of an integer hyperparameter n) to optimize the model using minimum/maximum scalar method. The minimum/maximum scalar method may be used for scaling down feature outliers in clusters or models. In some embodiments, for example, the agglomerative Ward clustering model applies a predetermined number of clusters. In some embodiments, the value of the hyperparameter n may be selected as a balance between maximizing the silhouette score of control clusters and producing an optimal number of control clusters. In some embodiments, one or more combinations of objective model metrics (e.g., silhouette scores) and subjective model metrics (e.g., user feedback on the usefulness of the clustering model) may be used to determine the hyperparameter n's value.

In some embodiments, the number of control clusters produced by the control clustering model may be determined by balancing the objective model metrics and subjective model metrics as discussed herein. In some embodiments, the control clustering model may be performed using a predetermined number of control clusters. The predetermined number of control clusters may be determined based on prior control clustering model outputs and assessment of the number of controls cluster generated compared to the relatedness of the controls within each control cluster generated by the control clustering model based on objective metrics.

At step 550 the control auditing system may assess the control clustering model to ensure its functionality and ability to create control clusters that meet the established requirements of the control auditing system. In some embodiments, the control auditing system may examine the control clusters using one or more objective model metrics. Objective model metrics may be quantifiable measures used to assess how well input controls are grouped within a cluster and how well clusters are separated from each other by a control clustering model. In some embodiments, an objective model metric may assess the ratio comparing a sum of dispersion between clusters generated by the control clustering model to a sum of dispersion within a given control cluster. An objective model metric may also create a control clustering model fit of the input controls that may be compared to a control clustering model's complexity.

Objective model metrics may include, (averaged) silhouette score, the Calinski-Harabasz (CH) score, and Bayesian Information Criterion (BIC). In some embodiments, the control auditing system may use one or more objective model metrics to assess input control groupings. For example, the control auditing system may apply one or more of either the silhouette score, the Calinski-Harabasz (CH) score, and Bayesian Information Criterion (BIC) to assess control clustering.

In some embodiments, the control auditing system may use one or more of the silhouette score or the Calinski-Harabasz (CH) score for their positive correlation to suggest a more ideal clustering in comparison to other control clustering models. The CH score may measure the ratio of variation between different control clusters compared to that found within a control cluster. In other embodiments, the control auditing system applies the silhouette score as the primary objective metric to examine the control clusters for control similarity within a control cluster.

In some embodiments, the control auditing system is further optimized by comparing the control clusters generated from a predetermined number of runs of a control clustering model using one or more subjective model metrics and one or more objective model metrics. For example, the control auditing system may be further optimized by comparing the control clusters generated from at least two runs of a control cluster model using one or more subjective model metrics and one or more objective model metrics. The comparison of the control clusters may be an assessment of the characteristics of the control cluster model outputs, such as the number of control clusters generated, the number of controls within each control cluster, and the labels generated for each control cluster. To conduct two runs of a control clustering model, the control auditing system may first create a control clustering model using a given set of controls and data. The control auditing system may compile objective model metrics such as silhouette score and subjective model metrics, such as user feedback and implement the feedback in the model. The control auditing system may then use the same controls and data used in the run or a new set of controls and run the data through the updated control clustering model, obtain feedback through subjective and objective model metrics and then compare the results between the runs to assess changes or run improvements.

In some embodiments, a processor may be used to access prior control cluster models, and their associated results to assess the control clusters produced and their associated objective and subjective metrics to determine potential means of control cluster optimization. For example, the control auditing system may compare input control groups, the silhouette scores of different control clusters, the associated differentiation between and within clusters, and user feedback on the usability and relatedness of the control clusters produced to further improve the control auditing system.

At step 550, the control auditing system may be configured to make at least one recommendation based on prior control clustering model outputs. These recommendations may be quantitative (e. g, the number of control clusters generated, or the weight assigned to each control within a dataset) or qualitative (e.g. the labels provided for each control cluster) in nature. For example, the control auditing system may recommend that the control clustering model only generate a predetermined number of clusters to optimize the similarity of the controls within a control cluster based on the results from a previous run.

In some embodiments, the control clustering models generated may track and implement control cluster optimization. In some embodiments, a processor may be used to access prior control cluster models and the associated results to track and apply the optimal conditions to future control clustering models. For example, the control clustering models may track the number of control clusters generated to determine the optimal number of control clusters for a given dataset. The control clustering models may also track the values of objective metrics for prior control clustering models to determine what values produce the most optimized control clusters and target these values of objective metrics in future control clustering model generation.

After the control clustering model is prepared and creates the optimized control clusters at step 550, process 500 may proceed to step 560. At step 560, the control auditing system may transform the optimized control clusters generated by the control clustering model to a readable file format. In some embodiments, a processor may prompt the control auditing system to transform the optimized control clusters. The readable file format may be in the form of a spreadsheet. The entries within the spreadsheet may include the control clusters created by the control clustering model.

After the optimized control clusters are transformed into a readable file format at step 560, process 500 may proceed to step 570. At step 570 the control clustering model may produce output labels to describe the optimized control clusters in a readable file format. In some embodiments, a processor may prompt the control clustering model to produce the output labels. These labels may describe the associated control clusters as discussed above. In some embodiments, the labels generated for each control cluster may be used in subsequent runs to train control clustering models and optimize subsequent uses of the control auditing system. In some embodiments, the output labels may be stored on a database. In some embodiments, training and optimization methods of the control clustering may be those discussed with respect to FIG. 3.

The foregoing description is presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

The disclosed embodiments may be implemented in a system, a method, and/or a computer program product. The computer program product may include a computer-readable storage medium (or media) having computer-readable program instructions thereon for causing a processor to carry out aspects (e.g., method steps) of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts described above. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of this disclosure are apparent from this detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

What is claimed is:

1. A system comprising:
a memory storing instructions; and
a processor configured to execute the instructions to:
receive input controls and data to a centralized repository;
assess features of the input controls to determine similarities between the input controls;
create a feature dataset based on the assessed similarities of the input controls;
generate a control clustering model, wherein the control clustering model is configured to create optimized control clusters based on optimization of at least one of a feature weight, a feature dataset, or the input controls;
based on the optimized control clusters, transform the optimized control clusters to a readable file format; and
prompt the control clustering model to produce output labels to describe the optimized control clusters in the readable file format.

2. The system of claim 1, wherein the processor is further configured to determine feature weights and descriptions.

3. The system of claim 1, wherein feature optimization is stochastic.

4. The system of claim 3, wherein the feature optimization includes minimizing the feature weight of the input controls to an optimal size.

5. The system of claim 4, wherein minimizing the feature weight of the input controls of a control cluster is completed to maximize at least one metric of a control clustering model.

6. The system of claim 4, wherein the control clustering model performs a stochastic feature weight optimization process for features of the control clustering model to produce optimized maximal metrics of the control clustering model.

7. The system of claim 4, wherein performing the feature optimization process further includes using one or more combinations of objective model metrics and subjective model metrics to produce the optimized maximal metrics.

8. The system of claim 7, wherein the control clustering model uses silhouette scores as an objective metric and user feedback as a subjective metric to produce optimized maximal metrics.

9. The system of claim 4, wherein the feature weight of the input controls is minimized using a maximum silhouette score.

10. The system of claim 9, wherein the maximum silhouettes score is an objective value indicator of a heightened similarity between a set of input controls.

11. The system of claim 1, wherein the processor is further configured to use a minimization algorithm configured to modulate the feature weight.

12. The system of claim 1, wherein the processor is further configured to:
create an unsupervised control clustering model that optimizes maximal metrics of the control clusters produced, wherein a number of the optimized control clusters is determined by balancing the objective model metrics and the subjective model metrics.

13. The system of claim 12, wherein the number of the optimized control clusters is a predetermined number of control clusters.

14. The system of claim 1, wherein the control clustering model uses a ratio comparing a first sum of dispersion between clusters generated by the control clustering model to a second sum of dispersion within a given control cluster as an objective metric and user feedback as a subjective metric to produce optimized maximal metrics.

15. The system of claim 1, wherein a control clustering model fit of the input controls is compared to a control clustering model complexity as an objective metric and user feedback as a subjective metric to produce optimized maximal metrics.

16. The system of claim 1, wherein a feature weight optimization process includes using one or more objective model metrics to produce optimized maximal metrics.

17. The system of claim 1, wherein the control clusters are further optimized by comparing the control clusters generated from at least two runs of a control clustering model using one or more subjective model metrics and one or more objective model metrics.

18. The system of claim 1, wherein the control clustering model is an unsupervised classification model.

19. The system of claim 1, wherein the processor is further configured to make at least one recommendation based on prior control clustering model outputs.

20. A method comprising:
receiving input controls and data to a centralized repository;
assessing features to determine a similarity between the input controls;
creating a feature dataset based on the similarity;
generating a control clustering model, wherein the control clustering model is configured to create optimized control clusters based on optimization of at least one of a features weight, a feature data set, or the input controls;
based on the optimized control clusters, transforming the optimized control clusters to a readable file format;
prompting the control clustering model to produce output labels to describe the optimized control clusters.

21. The method of claim 20, wherein the control clustering model is further configured to track and implement control cluster optimization.
